(19) United States
(12) Patent Application Publication
(10) Pub. No.: US 2019/0135277 A1
(43) Pub. Date: May 9, 2019

(54) VEHICLE AND CONTROL METHOD THEREOF

(71) Applicants: Hyundai Motor Company, Seoul (KR); Kia Motors Corporation, Seoul (KR)

(72) Inventors: Kyungdeuk Min, Hwaseong (KR); Jinbong Lee, Seoul (KR); Hoi Won Kim, Gwacheon (KR); Kwangsoo Hahm, Gunpo (KR)

(21) Appl. No.: 15/836,045

(22) Filed: Dec. 8, 2017

(30) Foreign Application Priority Data
Nov. 3, 2017 (KR) 10-2017-0145628

(51) Int. Cl. B60W 30/095; B60W 30/09

(52) U.S. Cl. CPC B60W 30/095; B60W 30/09; B60W 2550/141; B60W 2550/30; B60W 2520/10

(57) ABSTRACT

A vehicle configured to improve convenience of a driver by adjusting an automatic braking control time based on a situation around the vehicle when the vehicle is automatically braked and a control method thereof are provided. The vehicle includes a braking portion that obtains speed information of the vehicle and a first sensor that obtains information around the vehicle. A controller determines whether to perform automatic braking control of the vehicle based on the speed information of the vehicle. When the vehicle performs the automatic braking control, the controller calculates a collision possibility of the vehicle based on the information around the vehicle, and an automatic braking time of the braking portion based on the collision possibility of the vehicle.

### CROSS-REFERENCE TO RELATED APPLICATION

This application claims the benefit of Korean Patent Application No. 10-2017-0145628, filed on Nov. 3, 2017, the disclosure of which is incorporated herein by reference.

### BACKGROUND

### 1. Field of the Disclosure

The present disclosure relates to a vehicle and a control method thereof, and more specifically, to a safer automatic vehicle braking technology.

### 2. Description of the Related Art

An autonomous driving technology of a vehicle is a technology through which a vehicle automatically recognizes a state of a road and operates even though a driver does not engage a brake, a steering wheel, an accelerator pedal, and the like. An automatic vehicle speed control system, which is a key technology for realizing a smart vehicle, includes a highway driving assist (HDA, a technology through which a distance between vehicles is automatically maintained) system, a blind spot detection (BSD, a technology through which surrounding vehicles are detected and warned while a vehicle is reversed) system, an automatic emergency braking (AEB, a technology through which a braking system is operated when a driver does not recognize a preceding vehicle) system, a lane departure warning system (LDWS), a lane keeping assist system (LKAS, a technology through which a vehicle is prevented from departing from a lane without a turning signal), an advanced smart cruise control (ASCC, a technology through which a vehicle travels when a distance between vehicles is maintained at a predetermined constant speed), a traffic jam assist (TJA) system, and the like for autonomous vehicles.

Particularly, when a vehicle is stopped, an automatic vehicle speed control system of a vehicle is designed such that the vehicle automatically starts in about three seconds when a preceding vehicle starts. In addition, when the automatic vehicle speed control system is operated and the vehicle is stopped for three seconds or more due to the preceding vehicle, a driver is always required to input a restart signal thus resulting in low convenience since the driver's input is frequently required.

### SUMMARY

Therefore, it is an aspect of the present disclosure to provide a vehicle configured to improve convenience of a driver by adjusting an automatic braking control time based on the a situation around the vehicle when the vehicle is automatically decelerated and a control method thereof. Additional aspects of the disclosure will be set forth in part in the description which follows and, in part, will be obvious from the description, or may be learned by practice of the disclosure.

In accordance with one aspect of the present disclosure, a vehicle may include: a braking portion configured to obtain speed information of the vehicle; a first sensor configured to obtain information around the vehicle; and a controller configured to determine whether to perform automatic braking control of the vehicle based on the speed information of the vehicle. When the vehicle performs the automatic braking control, the controller may be configured to calculate a collision possibility of the vehicle based on the information around the vehicle, and an automatic braking time of the braking portion based on the collision possibility of the vehicle.

The vehicle may further include a communication unit configured to receive position information of the vehicle from a server, wherein the controller may be configured to determine a type of road on which the vehicle is traveling based on the position information received by the communication unit, and calculate a collision possibility of the vehicle based on the type of road on which the vehicle is traveling. The controller may further be configured to determine a local characteristic of the road on which the vehicle is traveling based on the position information received by the communication unit, and calculate a collision possibility of the vehicle based on the local characteristic of the road on which the vehicle is traveling.

The first sensor may be configured to obtain position information of at least another target object positioned near the vehicle, and the controller may be configured to calculate a collision possibility of the vehicle based on the position information of the at least another target object positioned near the vehicle. The controller may further be configured to determine whether to perform the automatic braking control of the vehicle based on position information of at least another target object positioned near the vehicle and the speed information of the vehicle.

The vehicle may further include a second sensor configured to obtain state information of a driver of the vehicle, wherein the controller may be configured to determine whether to perform the automatic braking control of the vehicle based on the state information of the driver of the vehicle and the speed information of the vehicle. The controller may be configured to decrease the automatic braking time when the collision possibility of the vehicle increases. The controller may be configured to increase the automatic braking time of the vehicle when the collision possibility of the vehicle decreases. The vehicle may further include an output portion configured to output at least one of whether the automatic braking control is performed and the automatic control time.

In accordance with another aspect of the present disclosure, a control method of a vehicle may include obtaining speed information of the vehicle, obtaining information around the vehicle, determining whether to perform automatic braking control of the vehicle based on the speed information of the vehicle, calculating a collision possibility of the vehicle based on the information around the vehicle when the vehicle performs the automatic braking control, and calculating an automatic braking time based on the collision possibility of the vehicle.

The control method may further include receiving position information of the vehicle from a server, wherein the calculating of the collision possibility of the vehicle may further include determining a type of road on which the vehicle is traveling based on the position information received by a communication unit, and calculating a collision possibility of the vehicle based on the type of road on which the vehicle is traveling. The calculating of the collision possibility of the vehicle may include determining a local characteristic of the road on which the vehicle is traveling based on the position information, and calculating a collision possibility of the vehicle based on the local characteristic of the road on which the vehicle is traveling.

The control method may further include obtaining position information of at least another target object positioned near the vehicle, wherein the calculating of the collision possibility of the vehicle may include calculating a collision possibility of the vehicle based on the position information of the at least another target object positioned near the vehicle. The determining of whether to perform the automatic braking control of the vehicle may further include determining whether to perform automatic braking control of the vehicle based on the position information of at least another target object positioned near the vehicle and the speed information of the vehicle.

The control method may further include obtaining state information of a driver of the vehicle, wherein the determining of whether to perform the automatic braking control of the vehicle may include determining whether to perform automatic braking control of the vehicle based on the state information of the driver of the vehicle and the speed information of the vehicle. The calculating of the automatic braking time may include decreasing the automatic braking time when the collision possibility of the vehicle increases. The calculating of the automatic braking time may include increasing the automatic braking time when the collision possibility of the vehicle decreases. The control method may further include outputting at least one of whether the automatic braking control is performed and the automatic control time.

### BRIEF DESCRIPTION OF THE DRAWINGS

These and/or other aspects of the disclosure will become apparent and more readily appreciated from the following description of the exemplary embodiments, taken in conjunction with the accompanying drawings of which:

FIG. 1 is a view illustrating a vehicle according to one exemplary embodiment of the present disclosure;

FIG. 2 is a view illustrating an inner space of the vehicle according to one exemplary embodiment;

FIG. 3 is a view illustrating a braking portion according to one exemplary embodiment;

FIG. 4 is a control block diagram according to one exemplary embodiment;

FIGS. 5A-5C are views for describing operations in which a collision possibility and an automatic braking control time are calculated according to one exemplary embodiment of the present disclosure;

FIGS. 6A and 6B are views showing outputs of information related to automatic braking control according to one exemplary embodiment of the present disclosure;

FIG. 7 is a view for describing obtaining of information related to a state of a user according to one exemplary embodiment of the present disclosure; and

FIGS. 8 to 10 are flowcharts according to one exemplary embodiment;

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The same reference number refers to the same component throughout the present specification. The present specification does not describe all elements of the exemplary embodiments, and general contents in the art of the present disclosure or repeated contents in the embodiments will be omitted. Terms, such as a part, a module, a member, and a block may be implemented by software or hardware, and depending on the exemplary embodiments, a plurality of parts, modules, members, or blocks may be provided as a single thereof, or may also be provided with a plural thereof.

Throughout the specification, when one part is referred to as being “connected” to another part, it includes cases in which one part is directly connected to another part, and one part is indirectly connected to another part, and the indirect connecting includes connecting through wireless communication. The terms first, second, and the like are used to distinguish one element from another, but these elements are not limited by the above-described terms. Elements of the disclosure referred to in singular may number one or more, unless the context clearly indicates otherwise. Identification codes of operations are used for the sake of convenience of description, and do not mean an order of the operations, and the operations may be performed in an order different from a described order, unless the context clearly indicates a specific order.

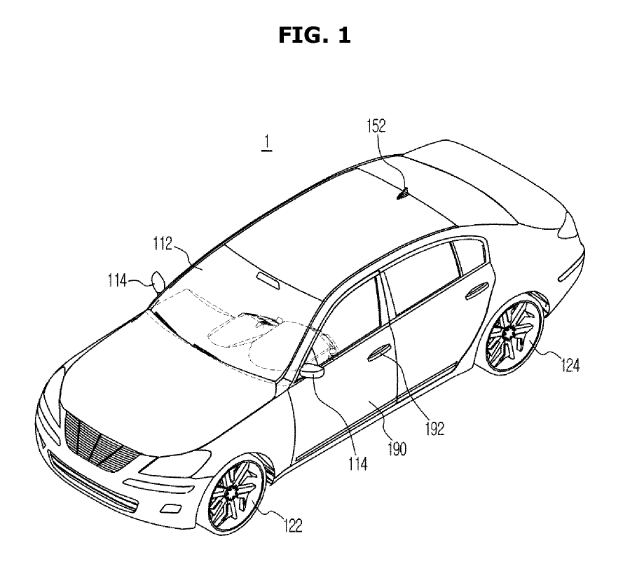

Hereinafter, operational principles and embodiments of the present disclosure will be described with reference to the accompanying drawings. FIG. 1 is a view illustrating a vehicle according to one exemplary embodiment of the present disclosure. FIG. 1 is a view illustrating a vehicle according to one exemplary embodiment of the present disclosure. A vehicle 1 illustrated in FIG. 1 has a following external structure.

A windshield 112 is disposed at an upper front side of a main body 110, and provides a front view to occupants inside the vehicle 1 and protects the occupants from wind. Exterior mirrors 114 provide a side view and a side rear view of the vehicle 1 to the occupant. Each of the exterior mirrors 114 may be disposed at right and left doors 190. The doors 190 are pivotably disposed at a left and a right of the main body 110, and configured to allow the occupants to enter and exit the vehicle 1 when the doors 190 are open and shield an inside from the outside of the vehicle 1. The doors 190 may be locked/unlocked using door locking devices 192. A method of locking/unlocking of the door locking devices 192 may include a method in which a user approaches the vehicle 1 and directly manipulates a button or lever of each of the door locking devices 192 and a method in which a user remotely locks/unlocks using a remote controller and the like at a position away from the vehicle 1.

An antenna 152 configured to receive a signal of broadcasting/communication of a telematics service, a digital multimedia broadcasting (DMB), a digital television (TV), a global positioning system (GPS), and the like, may be a multifunctional antenna configured to receive various types of broadcasting/communication signals or a single functional antenna configured to receive one broadcasting/communication signal. Front wheels 122 and rear wheels 124 are respectively disposed at a front and a rear of the vehicle 1, and are configured to be rotated by receiving a power from an engine (not shown).

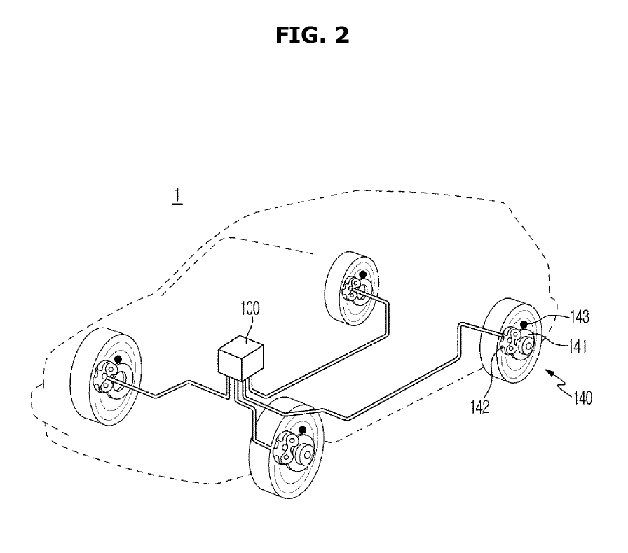

FIG. 2 is a view illustrating an inner space of the vehicle according to one exemplary embodiment. The inner space of the vehicle 1 illustrated in FIG. 2 has a following structure.

A dashboard 256 may protrude toward an occupant from a lower portion of the windshield 112. Various devices for the occupant to manipulate the vehicle 1 may be installed in the dashboard 256. A driver's seat 258 may be provided and a driver may manipulate various devices installed on the dashboard 256. The driver's seat 258 may allow the driver to be in a stable posture to look in a forward direction of the vehicle 1, watch various devices of the dashboard 256, and drive the vehicle 1.

A cluster display 260 may be disposed at the dashboard 256 in front of the driver's seat 258, and may be configured to display operational information and the like of the vehicle 1. The cluster display 260 may include a speed gage 260 configured to display a running speed of the vehicle 1, and a revolutions-per-minute (RPM) gage 262 configured to display a rotational speed of a power apparatus (not shown). An output portion 130, which is a head unit, may be a multimedia device configured to execute various multimedia functions based on a manipulation command of the occupant. A navigation device 200 may be configured to perform a navigation function for guiding a vehicle toward a destination, and audio and video functions. The output portion 130 may be configured to perform all the audio, video, and navigation functions, but may include some functions without including all the audio, video, and navigation functions.

The output portion 130 may include a display configured to display information of a road on which the vehicle 1 is traveling or a path toward a destination input by the occupant. In addition, the output portion 130 may be electrically connected to a speaker 216, and an acoustic signal of the output portion 130 may be transmitted to the speaker 216 and output therethrough. In addition, the output portion 130 may be connected to a user terminal 250 via a wired method such as a universal serial bus (USB) cable 292. In addition, the output portion 130 may be configured to perform a near field communication. The output portion 130 may be connected to the user terminal 250 in a method such as a pairing and the like through the near field communication to perform the near field communication. The output portion 130 may operate based on a voice recognition control. Accordingly, a voice recognition button 204 may be installed at a steering wheel 120-2, and a microphone 206 may be installed above the driver's seat 258. The voice recognition button 204, the microphone 206, and the speaker 216 may be used as auxiliary units for the voice recognition control of the navigation device 200.

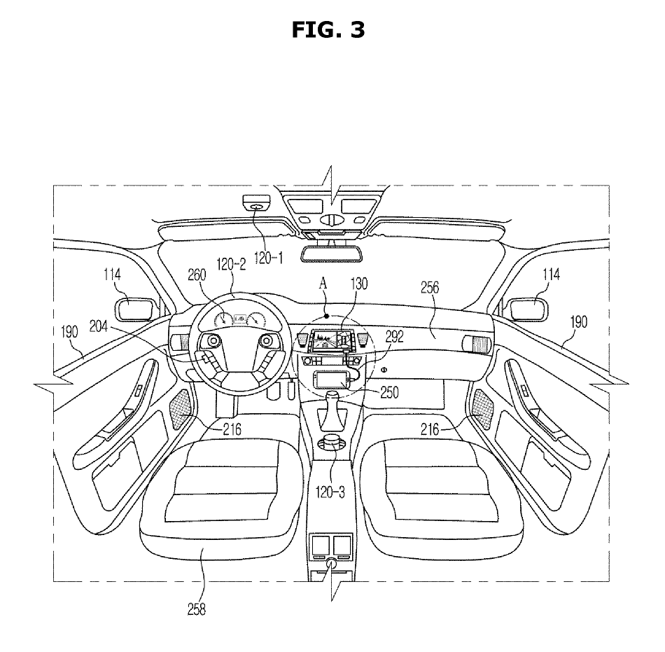

FIG. 3 is a view illustrating a braking portion according to one exemplary embodiment. Referring to FIG. 3, the vehicle may include a braking portion. The braking portion may include a booster and a master cylinder of a system such as a typical brake, a controller 100 which may be an electronic control unit, a hydraulic control unit (HCU), wheel speed sensors 143 configured to detect speeds of the wheels, a pedal travel switch (PTS) configured to detect a state in which a brake pedal is engaged, disc brakes 141, and calipers 142.

The disc brakes 141 generate a braking force by pressing pads against both surfaces of a disc configured to rotate together with the wheel and rubbing the pads against the both surfaces. For a sealed type drum bake, a disadvantage in that a drum expands due to frictional heat and thus the brake does not operate when the brake is repeatedly used may be complemented. Main parts of an anti-lock braking system (ABS) may include discs configured to rotate together with wheel hubs, pads pressed against the discs and configured to generate a frictional force, wheel cylinders to which hydraulic pressures are applied, and the calipers 142 in which the wheel cylinders are disposed.

Each of the calipers 142, which are devices configured to press the pads of the vehicle against the disc brakes 141 and brake the front wheels, hydraulically operates. The caliper 142 may be formed in a shape to cover the brake disc of the front wheel. When the brake operates, and a hydraulic pressure is applied to the master cylinder, brake oil in the cylinder generates a hydraulic pressure and a force is applied to a left and a right in the cylinder. In particular, a force applied to the left allows a piston to slide and presses an inner pad against the disc, and a force applied to the right allows a housing to slide in a right direction. Then, an outer pad may be pressed against the disc and generates a frictional force together with the inner pad.

When the braking is released, the piston is restored to an original location based on a restoring force of a seal piston, and the inner pad maintains a distance to the disc due to rotation of the disc. Simultaneously, while a pressing force of the outer pad is released by a sliding action of the housing, a distance between the outer pad and the disc may be maintained, and thus a remaining torque may be removed. Since in a vehicle in which the ABS is installed, the wheel speed sensor 143 is installed at each of the wheels, a balance of four wheels may be maintained by pumping one wheel when information detected at the wheels is analyzed and the wheel is determined to be locked. Accordingly, since a skid phenomenon in which the vehicle slides does not occur, a driver may maintain a control force, the wheel is not locked, and thus a braking distance may also be further decreased.

The wheel speed sensor 143 may be installed at each of the four front and rear wheels and may be configured to detect a rotational speed of the wheel with a change in magnetic field flux at a tone wheel and the sensor and input the rotational speed to a computer. A controller may be configured to calculate a running distance at every situation which will be described below based on a wheel speed obtained from the wheel sensor. In particular, as will be described below, the controller of the vehicle may be configured to start automatic braking control based on a running distance per unit time measured by the wheel speed sensor 143.

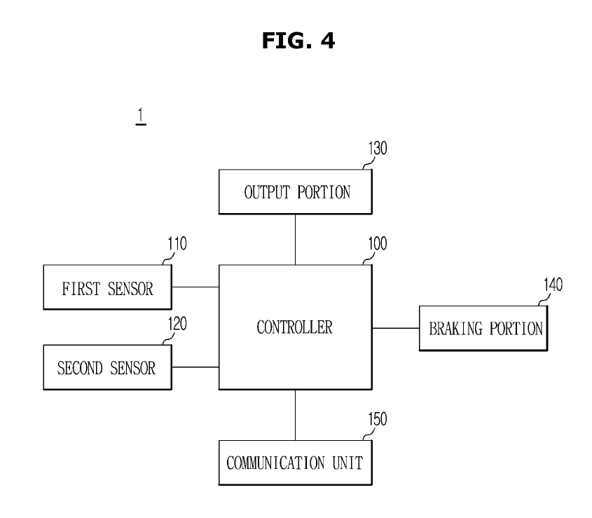

FIG. 4 is a control block diagram according to one exemplary embodiment. Referring to FIG. 4, the vehicle 1 according to one exemplary embodiment may include a braking portion 140, the controller 100, the output portion 130, a communication unit 150, a first sensor 110, and a second sensor 120. The controller 100 may be configured to operate the components of the vehicle.

The braking portion 140 may be configured to decelerate (e.g., brake) the vehicle 1, and may include the calipers, the disc brakes, and the wheel speed sensors as described above. The braking portion 140 may be configured to obtain speed information of the vehicle 1. The first sensor 110 may be configured to obtain information around the vehicle 1. In addition, the first sensor 110 may be configured to obtain position information of at least another target object positioned near the vehicle 1.

The first sensor 110 may include a video camera and a radar. The wheel speed sensor may be installed at the wheel of the vehicle 1, may be configured to detect the number of rotations of each of the wheels, and transmit information related to the number of rotations of the each of the wheels to the controller 100. The video camera may be configured to capture images around the vehicle 1 and transmit the images to the controller 100, and the controller 100 may then be configured to derive information such as the presence of another vehicle 1 in the proximity of the subject vehicle 1, weather information, and the like based on the images. The radar may be configured to obtain environmental information around the vehicle 1 by transmitting a radio wave to surroundings of the vehicle 1, and transmit the environmental information to the controller 100.

Further, the second sensor 120 may be configured to obtain state information of a driver within the vehicle 1. The second sensor 120 is not limited as long as a device may be configured to detect a state of the driver as will be described below. The second sensor 120 may be configured to detect a heart rate, an eye condition, a face position, and the like of the driver. The second sensor 120 may include a plurality of electrodes installed at a steering wheel, a driver's seat, an internal camera, a jog shuttle, and the like. The second sensor 120 will be described in detail below. When the controller 100 determines whether to perform automatic braking control of the vehicle 1 based on speed information of the vehicle 1, and the vehicle 1 performs the automatic braking control, the controller 100 may be configured to calculate a collision possibility of the vehicle 1 based on information therearound, and calculate an automatic braking time of the braking portion 140 based on the collision possibility.

In addition, the controller 100 may be configured to determine a type of road on which the vehicle 1 is traveling based on the position information received by the communication unit 150. The controller 100 may be configured to calculate a collision possibility of the vehicle 1 based on the position information. The controller 100 may further be configured to detect local characteristics of the road on which the vehicle 1 is traveling based on the position information received by the communication unit 150. The local characteristics refers to characteristics of a road provided for traffic such as a crosswalk, an intersection, a branch, a tunnel, an overpass, and a number of lanes provided on the road.

Further, the controller 100 may be configured to calculate a collision possibility of the vehicle 1 based on position information of at least another target object positioned near the vehicle 1. The controller 100 may be configured to determine whether to perform automatic braking control of the vehicle 1 based on the position information of the at least another target object positioned near the vehicle 1 and the speed information of the vehicle 1. In addition, the controller 100 may be configured to determine whether to perform automatic braking control of the vehicle 1 based on state information of a driver within the vehicle 1 and the speed information of the vehicle 1.

When the controller 100 calculates a collision possibility as described above, and the collision possibility increases, the controller 100 may be configured to decrease an automatic braking time. Conversely, when a collision possibility of the vehicle 1 decreases, the controller 100 may be configured to increase the automatic braking time. The controller 100 may be formed with a memory (not shown) configured to store an algorithm for executing operations of elements in the vehicle 1 or data for a program implementing an algorithm, and a processor (not shown) configured to perform the above-described operations using the data stored in the memory. The memory and the processor may be formed as individual chips. Alternatively, the memory and the processor may be formed as a single chip.

The controller 100 may include at least one among a nonvolatile memory device such as a cache, a read only memory (ROM), a programmable ROM (PROM), an erasable PROM (EPROM), an electrically EPROM (EEPROM), and a flash memory, a volatile memory device such as a random access memory (RAM), and a storage media such as a hard disk drive (HDD) and a compact disc-ROM (CD-ROM), but is not limited thereto.

Furthermore, the communication unit 150 may be configured to receive position information of the vehicle 1 from a server. The communication unit 150 may include a global positioning system (GPS) antenna. The communication unit 150 may be configured to receive satellite signals including a navigation message transmitted from satellites. The navigation message may be used to detect a current position of the vehicle 1, the total number of satellites from which the communication unit 150 may receive satellite signals, the number of satellites which may transmit satellite signals in a line-of-sight (LOS) way, a traveling speed of the vehicle 1, a multipath of a satellite signal of a candidate area, and the like. The information received by the communication unit 150 may be transmitted to the controller 100, and the controller 100 may be configured to obtain a running environment of the vehicle 1 based on the received information.

The output portion 130 may be configured to output at least one of whether automatic braking control is performed and an automatic control time. The output portion 130 may be formed in a display type, and formed as a liquid crystal display (LCD), a light emitting diode (LED), a plasma display panel (PDP), an organic light emitting diode (OLED), a cathode ray tube (CRT), and the like. The output portion 130 may include a visually displayed configuration such as a dashboard and a display, and include a speaker configured to output an auditory signal. At least one element may be added thereto or eliminated therefrom by corresponding to performances of the elements of the vehicle 1 illustrated in FIG. 4. In addition, it may be easily understood to those skilled in the art that relative locations of the elements may be changed by corresponding to performance or a structure of the system.

Meanwhile, each of the elements illustrated in FIG. 4 refers to a software and/or hardware element such as a field programmable gate array (FPGA) and an application specific integrated circuit (ASIC).

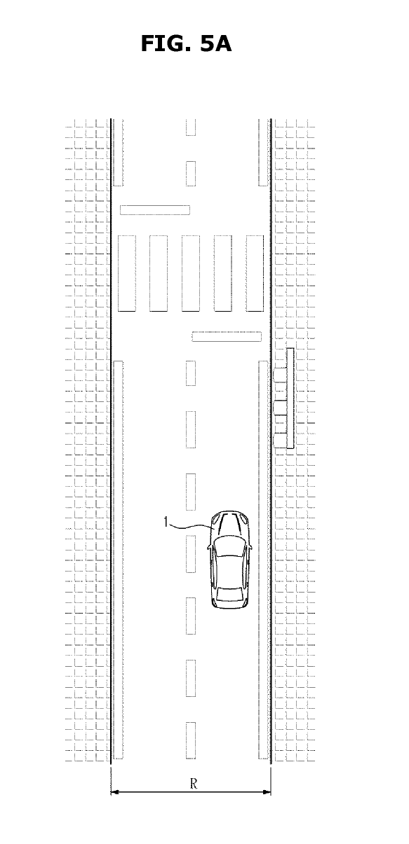

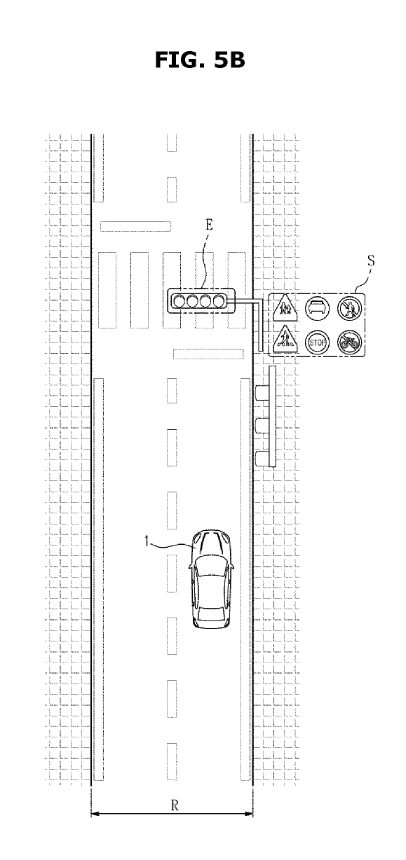

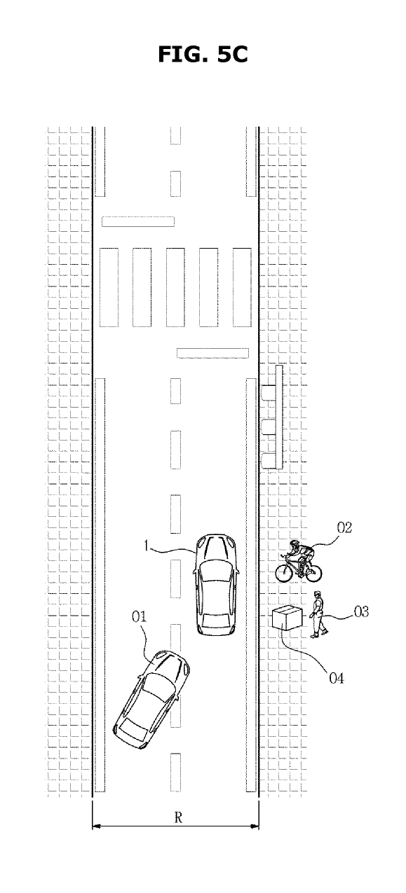

FIGS. 5A-5C are views for describing operations in which a collision possibility and an automatic braking control time are calculated according to one exemplary embodiment of the present disclosure. Referring to FIG. 5A, FIG. 5A shows an operation through which information related to a type of road R on which the vehicle 1 is traveling is obtained. The controller 100 may be configured to determine a type of road R on which the vehicle 1 is currently traveling based on GPS signals and map information received by the communication unit 150. The road on which the vehicle 1 is traveling may be a highway, a motorway, a main road, an interchange (IC)/junction (JC), a national road, a tunnel, or an overpass.

When the vehicle 1 is traveling on the highway or the motorway, since the vehicle 1 frequently travels at a constant speed, the controller 100 may be configured to determine that a collision possibility is low compared to the national road and the IC/JC. When the controller 100 determines that the vehicle 1 is traveling on a road in which a collision possibility is low, the vehicle 1 may be configured to calculate an automatic braking control time which is greater than that of when the vehicle 1 is traveling on a road in which a collision possibility is high. Meanwhile, when the vehicle 1 is traveling on the national road or in the tunnel, since a collision possibility is relatively high, the controller 100 may be configured to set a short automatic control time, a user may engage a brake pedal, and thus safe vehicle operation may be performed.

Referring to FIG. 5B, FIG. 5B is a view for describing an operation of the vehicle 1 when the vehicle 1 determines local characteristics E and S of a road on which the vehicle 1 travels. The controller 100 may be configured to determine the local characteristics E and S of a road on which the vehicle 1 is currently traveling based on GPS signals and map information received by the communication unit 150. The local characteristics E and S may include information regarding the presence of an intersection, a crosswalk, a branch, a guard rail, or a median, or information on the number of lanes. In addition, the local characteristics may include a stop line, a sign, a solid lane, a dotted lane, a central line, and a sidewalk. The controller 100 may be configured to determine an appearing possibility of another vehicle 1, pedestrians, and bicycles based on the local characteristics, and may be configured to calculate a collision possibility of the vehicle 1 based on the appearing possibility.

For example, when a crosswalk is located in front of the subject vehicle 1 (e.g., traveling vehicle), an appearing possibility of pedestrians is high, and thus the controller 100 may be configured to determine that a collision possibility is high, and decrease an automatic braking control time. In FIG. 5B, a signal light E is located over the road. The controller 100 may be configured to detect that the signal light E is located in front of the vehicle 1 based on a signal received by the communication unit 150. When the controller 100 detects the signal light E, the controller 100 may be configured to calculate an automatic braking control time based on a blinking time of the signal light E. In addition, the controller 100 may be configured to determine various other local characteristics S based on signals received by the communication unit 150 and a collision possibility of the vehicle 1 based on the local characteristics S, and calculate an automatic braking control time.

Referring to FIG. 5C, FIG. 5C is a view for describing an operation through which the vehicle 1 obtains position information of target objects therearound. The first sensor 110 may include the wheel speed sensor, the video camera, and the radar. The first sensor 110 may be configured to obtain position information of another vehicle O1, a bicycle O2, a pedestrian O3, and another target object O4 positioned near the vehicle 1. Specifically, the vehicle 1 may be configured to detect distance, relative speeds and trajectories of the pedestrian, the bicycle, and the other vehicle 1, and determine whether the pedestrian, the bicycle, or the other vehicle 1 will enter a traveling direction of the vehicle 1 or an entering possibility, and calculate a collision possibility on the basis thereof.

In FIGS. 5A to 5C, various cases in which automatic braking control times are calculated are described, and hereinafter, an operation in which the controller 100 calculates an automatic braking control time will be described.

T=T+T2 Equation 1

Referring to Equation 1, T refers to an automatic braking control time, T1 refers to a time calculated based on information received by the communication unit 150, and T2 refers to a time calculated based on information received by the first sensor 110. Specifically, T1 refers to a collision possibility and an automatic braking control time calculated by the controller 100 based on a type of road and local characteristics near the vehicle 1, and T2 refers to a collision possibility and an automatic braking control time calculated based on position information of another vehicle 1, a bicycle, and a pedestrian therearound obtained by the first sensor 110.

When a collision possibility is high, the controller 100 may be configured to decrease T1 and T2, and when a collision possibility is low, the controller 100 may also be configured to decrease T1 and T2. Particularly, T2 may become a negative number. For example, when a collision possibility is low and the vehicle 1 is traveling on a motorway, T1 may be calculated to be a value equal to or greater than a predetermined value, but even when there are many other vehicles 1 or target objects which have high collision possibility, T2 becomes a negative number, and a short automatic braking control time may be calculated.

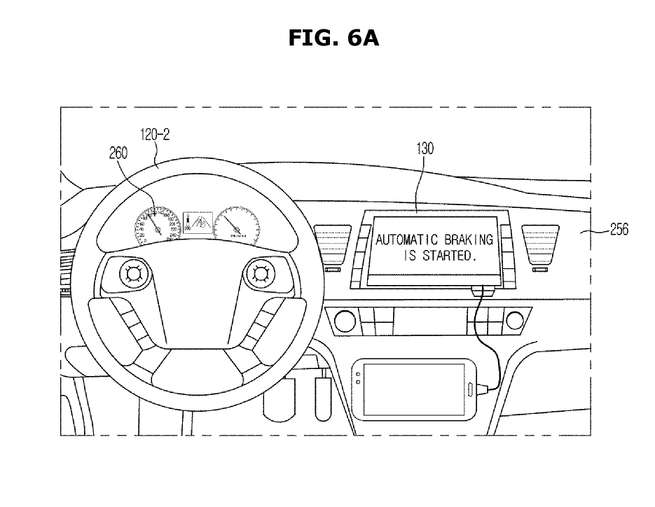

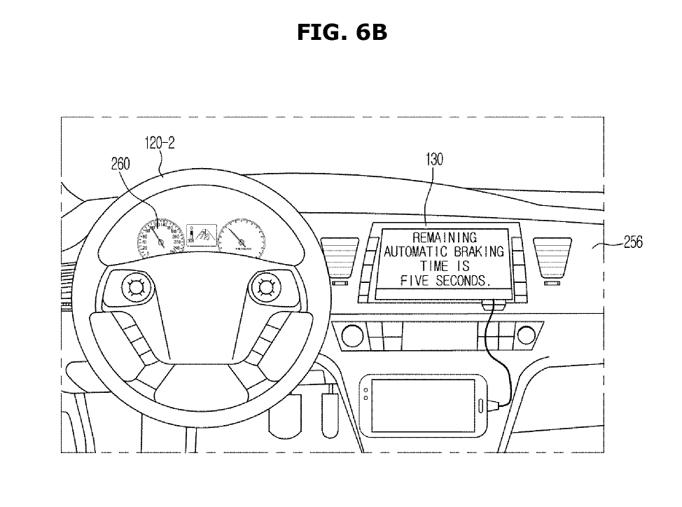

Meanwhile, FIGS. 5A to 5C are merely examples to describe the operations of the present disclosure, and a type of operation through which an automatic braking control time is set is not limited thereto. FIGS. 6A and 6B are views showing outputs of information related to automatic braking control according to one exemplary embodiment of the present disclosure.

Referring to FIG. 6A, the controller 100 may be configured to start automatic braking control based on speed information of the vehicle 1 obtained by the braking portion 140. In other words, when a speed of the vehicle 1 decreases to a value equal to or less than a predetermined value, the controller 100 may be configured to determine that the vehicle 1 brakes or is being decelerated, and start the automatic braking control. In addition, the controller 100 may be configured to operate the braking portion 140 to provide a minimum braking pressure to prevent the vehicle 1 from moving due to a slope and a torque.

In addition, the controller 100 may be configured to determine whether to start automatic braking control by measuring relative speed to a preceding vehicle 1 and similarity between the preceding vehicle 1 and the vehicles 1 based on position information of the preceding vehicle 1 obtained by the first sensor 110. As described above, in response to determining that the automatic braking control will be started, the output portion 130 may be configured to display that the automatic braking control is started, and also when the automatic braking control is complete, the output portion 130 may be configured to display that the automatic braking control is finished, and require a user to provide an input.

Referring to FIG. 6B, an automatic braking time calculated by the controller 100 as described above is displayed on the output portion 130. In the output portion 130, a start time and a remaining time to a finish time of automatic braking control may be displayed, and when a user inputs a braking signal within the remaining time, the automatic braking control may be finished. In FIGS. 6A-6B, information related to automatic braking control may be displayed on the display, but whether automatic braking control is started, and an automatic braking control time may be provided to the user through the display or the dashboard, or an auditory signal using the speaker. In addition, a type of information displayed on the output portion 130 is not limited.

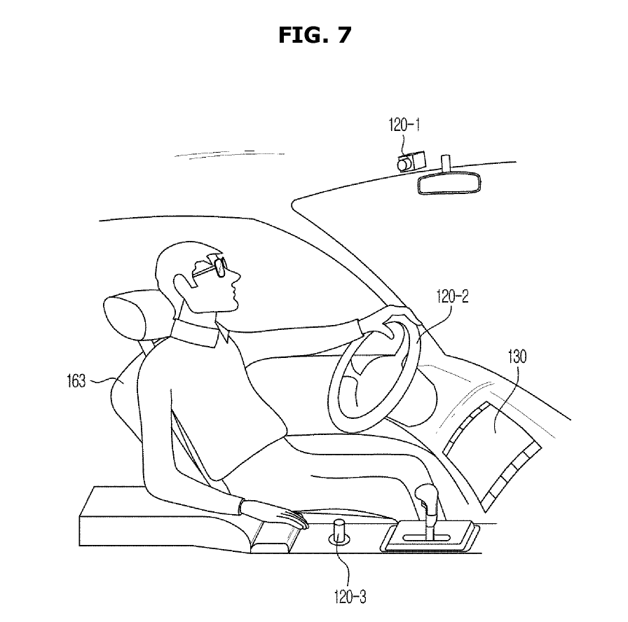

FIG. 7 is a view for describing obtaining of information related to a state of a user according to one exemplary embodiment of the present disclosure. Referring to FIG. 7, the second sensor 120 may include the steering wheel, the internal camera, a switch and the like,

The second sensor 120 may include the internal camera 120-1 configured to photograph a face of a driver and detect a state of the driver based on a captured image signal. For example, when a neck of the driver is bent at an angle greater than a predetermined angle, the controller 100 may be configured to determine that the driver is unable to drive the vehicle 1 based on the image photographed by the internal camera 120-1. In addition, the internal camera 120-1 may be configured to photograph the eyes of the driver, and when an image in which the eyes of the driver are closed is obtained and transmitted to the controller 100, the controller 100 may be configured to determine that the driver is unable to drive the vehicle 1.

Meanwhile, a driver detector may be configured to obtain a state of a driver based on a change amount of the steering wheel 120-2. For a typical traveling, a change amount of angle of the steering wheel 120-2 is minimal, but in when a physical condition of the driver becomes a concern based on the gathered information, since the angle of the steering wheel 120-2 may be rapidly or frequently changed, the driver detector may be configured to detect the change, and transmit related information to the controller 100, and the controller 100 may be configured to determine that the driver is unable driver the vehicle 1. As described above, when the controller 100 determines that the driver is unable to operate the vehicle 1 temporarily, the controller 100 may be configured to maintain a stopping control, and when this state is maintained for a predetermined period of time, the controller 100 may be configured to lock the brake to secure the driver's safety.

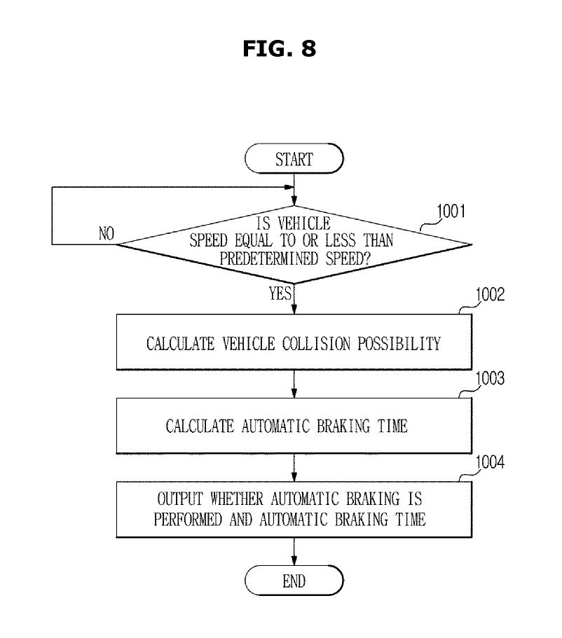

FIGS. 8 to 10 are flowcharts according to one exemplary embodiment. Referring to FIG. 8, when the controller 100 determines that a speed of the vehicle 1 is equal to or less than a predetermined speed, the controller 100 may be configured to start automatic braking control (1001). Then, a collision possibility of the vehicle 1 may be calculated based on information obtained by the communication unit 150 and the first sensor 110 (1002). The controller 100 may be configured to calculate an automatic braking time based on the collision possibility (1003), and output such information through the output portion 130 (1004).

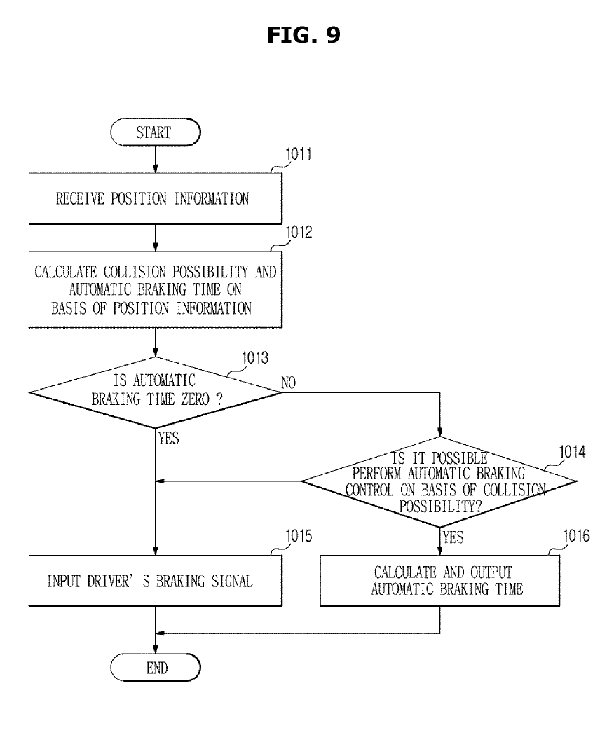

Referring to FIG. 9, the vehicle 1 may be configured to receive GPS signals through the communication unit 150 and receive position information of the vehicle 1 (1011). In addition, the controller 100 may be configured to obtain information related to a type of road on which the vehicle 1 is traveling and local characteristics of the road based on the position information, and calculate a collision possibility and an automatic braking control time based on the information (1012). When the automatic braking control time calculated by the controller 100 is zero seconds, a driver directly inputs a braking signal (1015) and the automatic braking control is finished. In addition, when the automatic braking control time is greater than zero seconds, the controller 100 may be configured to determine whether automatic braking control is possible based on the collision possibility (1014), and when the automatic braking control is possible, an automatic braking control time may be calculated and output (1016). In addition, when automatic braking control is impossible, the driver's braking signal may be input and the automatic braking control may be finished (1015).

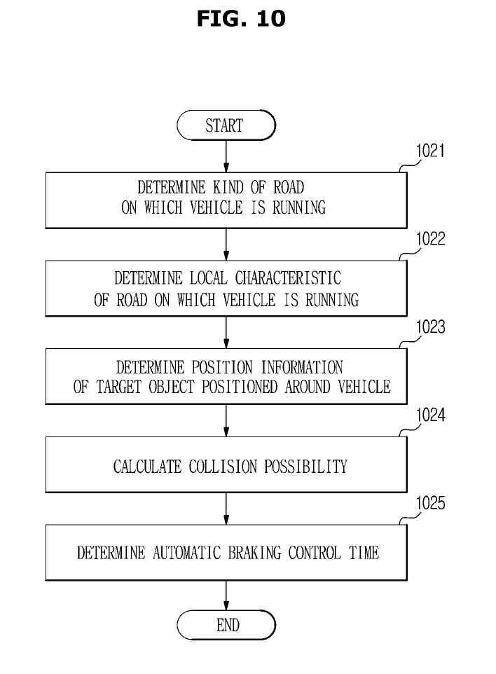

FIG. 10 is a flowchart showing an entire process through which an automatic braking control time is calculated. The vehicle 1 may be configured to determine a type of road on which the vehicle 1 is traveling based on a signal received by the communication unit 150 (1021). In addition, the controller 100 may be configured to determine local characteristics of the road on which the vehicle 1 is traveling (1022). Then, the controller 100 may be configured to obtain position information of a target object near the vehicle 1 obtained by the first sensor 110 (1023). The controller 100 may be configured to calculate a collision possibility of the vehicle 1 based on the position information of the target object (1024). The controller 100 may further be configured to determine an automatic braking control time of the vehicle 1 based on the collision possibility of the vehicle 1 (1025).

Meanwhile, the disclosed exemplary embodiments may be realized as a form of a recording medium configured to store commands executable by a computer. The commands may be stored as a program code form, and when the commands are executed by processors, program modules are generated and the disclosed embodiments may be performed. The recording medium may be formed as a non-transitory computer-readable recording medium. The non-transitory computer-readable recording medium includes any kind of recording medium storing commands decodable by the computer. For example, the recording medium may include, a ROM, a RAM, a magnetic tape, a magnetic disk, a flash memory, an optical data storage device, and the like.

As is apparent from the above description, a vehicle and a control method thereof according to one exemplary embodiment may improve convenience of a driver by adjusting an automatic braking control time based on a situation around the vehicle when the vehicle is automatically braked.

As described above, the disclosed exemplary embodiments have been described with reference to the accompanying drawings. It will be understood to those skilled in the art that the present disclosure may be made as different forms even without modifying the technical spirit or essential features of the present disclosure. The above-described exemplary embodiments should be interpreted as only examples and not for purposes of limitation.

### REFERENCE NUMERALS

1: VEHICLE
100: CONTROLLER
110: FIRST SENSOR
120: SECOND SENSOR
130: OUTPUT PORTION
140: BRAKING UNIT
150: COMMUNICATION UNIT

What is claimed is:

1. A vehicle, comprising:
a braking portion configured to obtain speed information of the vehicle;
a first sensor configured to obtain information around the vehicle; and
a controller configured to determine whether to perform automatic braking control of the vehicle based on the speed information of the vehicle,
wherein, when the vehicle performs the automatic braking control, the controller is configured to calculate a collision possibility of the vehicle based on the information around the vehicle, and an automatic braking time of the braking portion based on the collision possibility of the vehicle.

2. The vehicle of claim 1, further comprising:
a communication unit configured to receive position information of the vehicle from a server,
wherein the controller is configured to:
determine a type of road on which the vehicle is traveling based on the position information received by the communication unit; and
calculate a collision possibility of the vehicle based on the type of road on which the vehicle is traveling.

3. The vehicle of claim 2, wherein the controller is configured to:
determine a local characteristic of the road on which the vehicle is traveling based on the position information received by the communication unit; and
calculate a collision possibility of the vehicle based on the local characteristic of the road on which the vehicle is traveling.

4. The vehicle of claim 1, wherein the first sensor is configured to obtain position information of at least another target object positioned near the vehicle and the controller is configured to calculate a collision possibility of the vehicle based on the position information of the at least another target object positioned near the vehicle.

5. The vehicle of claim 1, wherein the controller is configured to determine whether to perform the automatic braking control of the vehicle based on of position information of at least another target object positioned near the vehicle and the speed information of the vehicle.

6. The vehicle of claim 1, further comprising:
a second sensor configured to obtain state information of a driver within the vehicle,
wherein the controller is configured to determine whether to perform the automatic braking control of the vehicle based on the state information of the driver within the vehicle and the speed information of the vehicle.

7. The vehicle of claim 1, wherein the controller is configured to decrease the automatic braking time when the collision possibility of the vehicle increases.

8. The vehicle of claim 1, wherein the controller is configured to increase the automatic braking time of the vehicle when the collision possibility of the vehicle decreases.

9. The vehicle of claim 1, further comprising:
an output portion configured to output at least one of whether the automatic braking control is performed and the automatic control time.

10. A control method of a vehicle, comprising:
obtaining, by a controller, speed information of the vehicle;
obtaining, by the controller, information around the vehicle;
determining, by the controller, whether to perform automatic braking control of the vehicle based on the speed information of the vehicle;
calculating, by the controller, a collision possibility of the vehicle based on t the information around the vehicle when the vehicle performs the automatic braking control; and
calculating, by the controller, an automatic braking time based on the collision possibility of the vehicle.

11. The control method of claim 10, further comprising:
receiving, by the controller, position information of the vehicle from a server,
wherein the calculating of the collision possibility of the vehicle includes:
determining, by the controller, a type of road on which the vehicle is traveling based on the position information received by a communication unit; and
calculating, by the controller, a collision possibility of the vehicle based on the type of road on which the vehicle is traveling.

12. The control method of claim 11, wherein the calculating of the collision possibility of the vehicle includes:
determining, by the controller, a local characteristic of the road on which the vehicle is traveling based on the position information; and
calculating, by the controller, a collision possibility of the vehicle based on the local characteristic of the road on which the vehicle is traveling.

13. The control method of claim 10, further comprising:
obtaining, by the controller, position information of at least another target object positioned near the vehicle,
wherein the calculating of the collision possibility of the vehicle includes calculating, by the controller, a collision possibility of the vehicle based on the position information of the at least another target object positioned near the vehicle.

14. The control method of claim 10, wherein the determining of whether to perform the automatic braking control of the vehicle further includes:
determining, by the controller, whether to perform automatic braking control of the vehicle based on position information of at least another target object positioned near the vehicle and the speed information of the vehicle.

15. The control method of claim 10, further comprising:
obtaining, by the controller, state information of a driver within the vehicle,
wherein the determining of whether to perform the automatic braking control of the vehicle includes determining, by the controller, whether to perform automatic braking control of the vehicle based on the state information of the driver within the vehicle and the speed information of the vehicle.

16. The control method of claim 10, wherein the calculating of the automatic braking time includes:
decreasing, by the controller, the automatic braking time when the collision possibility of the vehicle increases.

17. The control method of claim 10, wherein the calculating of the automatic braking time includes:
increasing, by the controller, the automatic braking time when the collision possibility of the vehicle decreases.

18. The control method of claim 10, further comprising:
outputting, by the controller, at least one of whether the automatic braking control is performed and the automatic control time.
